(19) United States
(12) Patent Application Publication
(10) Pub. No.: US 2023/0259770 A1
(43) Pub. Date: Aug. 17, 2023

(54) APPARATUS AND METHOD FOR AUDIO DATA MANAGEMENT AND PLAYOUT MONITORING

(71) Applicant: Global Media Group Services Limited, London (GB)

(72) Inventors: Angelos OIKONOMOPOULOS, London (GB); Liam WHITESIDE, London (GB)

(21) Appl. No.: 18/168,837

(22) Filed: Feb. 14, 2023

(30) Foreign Application Priority Data
Feb. 15, 2022 (GB) 2202016.8

(51) Int. Cl. G06N 3/08; G06F 3/16

(52) U.S. Cl. CPC G06N 3/08; G06F 3/16

(57) ABSTRACT

A data management apparatus, a method, and a computer program product for establishing personal characterisations of users. A first set of data representing, for each user of a group of users, one or more categories of user attribute data is received. The group of users includes a first and second groups of users, where the first and second groups have no users in common. A second set of data representing, for each user in the first group, one or more behavioural characteristics is received. A weighted processing network is trained to form, for each user in the first group, relationships between categories of user attribute data of the first set of data and behavioural characteristics of the second set of data. A third set of data representing, for each user in the second group, behavioural characteristic(s) present in the second set of data is generated using the formed relationships.

### CROSS-REFERENCE TO RELATED APPLICATIONS

The present application claims priority to United Kingdom Patent Application No. GB2202016.8, filed Feb. 15, 2022, and entitled “Apparatus and Method for Audio Data Management and Playout Monitoring”, and incorporates its disclosure herein by reference in its entirety.

### TECHNICAL FIELD

In some implementations, the current subject matter generally relates to managing known user data from audio stream information in order to infer user characteristics and/or unknown user data

### BACKGROUND

Since the uptake of at home working, companies have needed to ensure that sensitive data accessible to employees remains secure and protected against security threats. Understanding the behaviour of users is therefore paramount for enhancing security systems for companies in order to protect sensitive data. Such threats may include the unauthorised accessing of the sensitive company information by a user who is not an employee of the company and is therefore not authorised to have access. It is thus beneficial to understand the characteristics of the users who are authorised to access the system and to identify users who are accessing the system but are not authorised to.

At present the behaviour and characteristics of current authorised employees is known as their data may be collected when they use company equipment or access the company system from home. However, for unknown or new users there is no such known data and thus it is beneficial to provide a means of generating user characteristics for these users based on their activities and the known data about authorised users.

In general, online user characteristics and behaviour may be achieved by collecting data associated to users when they access a webpage or click a link. When this occurs, a data tag known as a cookie is generated on the user’s device and is then transmitted to the server. This cookie may contain identifying information about the user, such as, their email address, location and the other webpages they have visited. This information may be used by a security system to compare the behaviour of authorised users in order to detect unauthorised users who are accessing the company system. It may also be utilised by a media content provider to identify users.

While cookie data described above is useful in providing identification of authorised users, it does not give a complete picture of the user’s preferences. Furthermore, the cookie data is limited to data that is already linked to the user, through previous searches, website visits or location information. For example, by predicting other likely other information about their behavioural references that would allow them to be identified.

In addition, users of a device may opt out of providing cookie data when consuming content e.g., streaming audio or listen to the audio via a medium that does not collect cookie data such as listening to audio content that does not require the use of a webpage, e.g., a radio. A further issue is that many users who for example, listen to audio streams, either online or offline, are difficult to identify. Furthermore, once cookie data has been received it may be used to understand the current habits of users based on the data that is collected and does not alone provide any insight into further user preferences that do not form part of the collected data.

There are also further industries in which user identification and in particular understanding user characteristics are beneficial in providing an improved service and more efficient allocation of processing resources when customising content for users.

One such example, is use in radio broadcasting to customise content and enhance the efficiency of broadcasting systems based on the preferences of users. In particular, how to customise content broadcast to particular users or demographics based on cookie data and optimise. It is further preferable for a broadcaster to be able to customise the content in a proactive manner to the augmented characteristics of users in order to enhance their broadcasting system.

The above obstacles mean that it is difficult to build comprehensive user data profiles, particularly in relation to user preference data. It is therefore one of the objects of the present disclosure is to provide an apparatus and method for generating the user characterisations of all users who consume media content.

It is therefore an object of the present disclosure to provide an apparatus and method that is capable of augmenting user characteristic data for unknown users in order to identify behavioural characteristic data of users and provide targeted advertising as well as improved resource allocation for content customisation.

### SUMMARY

In some implementations, the current subject matter relates to a data management apparatus (e.g., playout monitoring system) for establishing one or more personal characterisations of users. The data management apparatus may include one or more processors configured to: receive a first set of data representing, for each user of a group of users, one or more categories of user attribute data. The group of users may include a first group of users and a second group of users, where the first and second groups of users may have no users in common. The processor(s) may also receive a second set of data representing, for each of the users of the first group of users, one or more behavioural characteristics; train a weighted processing network to form, for each of the first group of users, relationships between the categories of user attribute data of the first set of data and the behavioural characteristics of the second set of data; and generate, using the relationships formed by the trained weighted processing network, a third set of data representing, for each of the users of the second group of users, one or more behavioural characteristics present in the second set of data. This may allow adverts to be targeted at users for whom only a basic first set of data can be collected and this allows optimisation of an apparatus used for providing media/audio content.

In some implementations, the current subject matter may be configured to include one or more of the following optional features. For example, a data management apparatus above, where the apparatus may be further configured to: receive, for a third group of users who have no users in common with the first and second groups of users, a fourth set of data representing one or more behavioural characteristics; input to the trained weighted network the fourth set of data; generate, using the relationships formed by the trained weighted network, for the user from the third group of users, a fifth set of data representing one or more categories of user data and/or one or more behavioural characteristics of the users. These features provide the advantage that users for which only a behavioural characteristic can be accessed due to anonymisation can be profiled and thus effectively catered to by advertisers as well as taken into account when providing other industrialisations as discussed at the end of this disclosure.

In some implementations, in the data management apparatus, the user attribute data may include user identification information. This feature allows a unique identifier to be placed on a user in order to track the movement of that user across multiple devices or for users to be characterised by a unique set of user attribute data.

In some implementations, the user identification information above may be an email address. This allows further identification of the user and users to be categorised and contacted when serving advertisements and customising content.

According to a further aspect, in the data management apparatus above one or more behavioural characteristics may include user listening data having information about user listening habits based on the audio content consumption of the first group of users. The use of listening habit data allows windows in which users listen to be configured and thus advertisements to be associated with the particular windows of time.

In some implementations, in the data management apparatus, the apparatus may be further configured to receive user identification information and/or user listening habit data specific to a unique user, and generate, using the trained weighted processing network the fifth set of data for the unique user. This allows data of the type of first and second sets of data to be generated for a new user given only some identifying information and a time window within which they consume content.

According to another aspect, there is provided the data management apparatus above, where the apparatus may be further configured to receive a single category from the first set of data for a user of the first group of users, generate using the trained weighted processing network first and/or second data associated to the unique user. This allows for each new user, data to be generated based on minimal identification and behavioural characteristic data.

According to another aspect, there is provided the data management apparatus above, where the second set of data may include information relating to the user’s preferences and/or interests. This allows a more accurate profile to be generated for the user and user behaviour and characteristics be better predicted using behavioural characteristic data.

According to another aspect, there is provided the data management apparatus above, where the weighted processing network may be a machine learning algorithm.

According to another aspect, there is provided the data management apparatus above, where, in training the weighted processing network to form relationships between the first set of data and the second set of data, the processor(s) may be configured to: compare the first sets of data and the second sets of data for each of the first group of users to other users from the first group of users; and identify combinations of the one or more user attributes from the first sets of data that are present in combination with one or more behavioural characteristics, for a plurality of users from the first group of users. This allows the relationships to be generated between sets of user data.

According to another aspect, there is provided the data management apparatus above, where, when generating the third set of data for the second group of users, the processor(s) may be further configured to: generate one or more probabilities that each of the second group of users has one or more behavioural characteristics that form the third set of data based on one or more user attributes that form the first set of data for the second group of users, where the probability may be based on the relationships formed between the first set of data and the second set of data of the first group of users. This allows customisation of the matched relationships that may be formed by the apparatus.

In some implementations, the current subject matter relates to a method of data management using machine learning for establishing one or more personal characterisations of users. The method may include providing a machine learning algorithm; inputting, to the machine learning algorithm, a first set of data representing, for each user of a group of users, one or more categories of user attribute data. The group of users may include a first group of users and a second group of users, where the first and second groups of users may have no users in common. The method may also include inputting, to the machine learning algorithm, a second set of data representing, for each of the users of the first group of users, one or more behavioural characteristics; training the machine learning algorithm to form for each of the first group of users, relationships between the categories of user attribute data of the first set of data and the behavioural characteristics of the second set of data; generating using the relationships formed by the machine learning algorithm, a third set of data representing, for each of the users of the second group of users, one or more behavioural characteristics present in the second set of data. This allows adverts to be targeted at users for whom only a basic first set of data can be collected and this allows optimisation of an apparatus used for providing media/audio content.

In some implementations, the method may also include inputting to the machine learning algorithm for a third group of users who have no users in common with the first and second groups of users, a fourth set of data representing one or more behavioural characteristics; generating, for the user from the third group of users, using the machine learning algorithm and the relationships formed from the first and second data sets, a fifth set of data representing one or more categories of user data and/or one or more behavioural characteristics of the users. These features provide the advantage that users for which only a behavioural characteristic can be accessed due to anonymisation can be profiled and thus effectively catered to by advertisers as well as taken into account when providing other industrialisations as discussed at the end of this disclosure.

In some implementations, the user attribute data may include user identification information. This feature allows a unique identifier to be placed on a user in order to track the movement of that user across multiple devices.

In some implementations, the user identification information may be an email address. This allows further identification of the user and users to be categorised and contacted when serving advertisements and customising content.

In some implementations, the behavioural characteristics may include user listening data having information about user listening habits based on the audio content consumption of the first group of users. The use of listening habit data allows windows in which users listen to be configured and thus advertisements to be associated with the particular windows of time.

In some implementations, the method may also include inputting, to the machine learning algorithm, user identification information user and/or user listening habit data specific to a unique user, generating, using the machine learning algorithm the fifth set of data for the unique user. This allows data of the type of first and second sets of data to be generated for a new user given only some identifying information and a time window within which they consume content.

In some implementations, the method may also include inputting to the machine learning algorithm a single category of the one or more categories from the first set of data for a user of the first group of users, generating, using the machine learning algorithm, first and/or second data associated to the unique user. This allows for each new user, data to be generated based on minimal identification and behavioural characteristic data.

In some implementations, the second set of data may include information relating to the user’s preferences and/or interests. This allows a more accurate profile to be generated for the user and user behaviour and characteristics be better predicted using behavioural characteristic data.

In some implementations, in training the machine learning algorithm to form relationships between the first set of data and the second set of data, the method may also include comparing the first sets of data and the second sets of data for each of the first group of users to the first and second data sets for each of the other users from the first group of users; and identifying combinations of the one or more user attributes from the first sets of data that are present in combination with one or more behavioural characteristics, for a plurality of users from the first group of users. This allows the relationships to be generated between sets of user data.

In some implementations, when generating the third set of data for each of the second group of users, the method may also include generating one or more probabilities that each of the second group of users has one or more behavioural characteristics that form the third set of data based on one or more user attributes that form the first set of data for the second group of users, wherein the probability is based on the relationships formed between the first set of data and the second set of data of the first group of users. This allows customisation of the matched relationships that may be formed by the apparatus.

### BRIEF DESCRIPTION OF THE FIGURES

FIG. 1 shows an example arrangement for providing audio content to users, according to some implementations of the current subject matter;

FIG. 2 shows example configurations of one or more processors of a data management apparatus, according to some implementations of the current subject matter;

FIG. 3 shows an example method for data management using a machine learning algorithm, according to some implementations of the current subject matter; and

FIG. 4 shows additional optional operations of the method for data management shown in FIG. 3, according to some implementations of the current subject matter.

### DETAILED DESCRIPTION

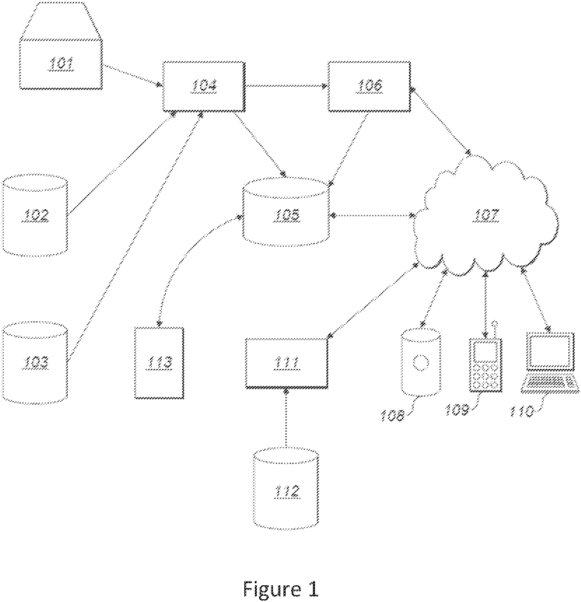

FIG. 1 shows a media playout system for providing audio content to users on a variety of receiving devices. Audio content is provided by a media source, which provides the main content of media to be provided. The main content could be generated live in an entertainment studio 101 or from the location of a live event such as a sports stadium. Alternatively, the main content could be pre-recorded and stored in a first media store 102. The media playout system may further include a second store 103 which stores interstitial items of playout content. In some implementations, the interstitial items may be advertisements. Alternatively, or in addition, other types of content that are played out during breaks in the main content stream may be used, such as public may include announcements, short documentaries or artistic content. The interstitial item may include a media element and has metadata associated with it which indicates the identity of the item and/or an attribute of the item that is to be used for identification purposes.

The media playout system may include a management suite 104 that has access to both the primary programming provided from either the live entertainment source 101 or the first media store 102 and the interstitial items stored in the second store 103. In some scenarios the first media store 102 and the second store 103 may be combined into a single store. The management suite 104 collates the primary programming and the interstitial items to generate a content stream that can be streamed to one or more users. The management suite 104 may intersperse one or more advertisements retrieved from the advertisement store into the main content in order to create the content stream to be played out. The content stream may be played out from its start at a time when it is requested by a user (in other words, it may be played out on demand), or it may be played out with a predetermined start time that is independent of when it is requested by a consumer.

Different content streams may be provided to different consumers for the same main content. For some users, interstitial items may not be provided between their primary content. Other users may receive content streams that may include different interstitial items for their main content. The management suite 104 stores in a database 105 an indication of which interstitial items have been played to which consumers.

The content streams to be played out are passed through the management suite 104 to a media server 106. The media server 106 encodes each content stream into a suitable digital format and transmits it over the internet 107 to any devices that have requested it. Examples of devices that may receive the content stream are smart speakers 108, mobile devices 109 and fixed computing devices 110. Different devices can be used to receive the media streams depending on the preference of an individual user. In some examples, the same user may own multiple receiving devices, and may use these multiple receiving devices to listen to the content stream. When any of the devices 108, 109, 110 receive the media feed, a processor of the device decodes the media feed into audio data and a user interface, and the device plays out that audio data. For some devices, the user interface could include a loudspeaker and/or a display.

When a content stream is provided to a receiving device 108, 109, 110, its metadata may be transmitted to the device together with the media content. In addition to indicating the identity of the item and/or an attribute of the item, the metadata may also indicate one or more receiving conditions of the content stream by the receiving device. A receiving condition may be defined as any criterion that indicates a condition in which the transmission was received. Examples of receiving conditions include the time of day at which the transmission was received, or the radio station that it was received from.

In addition to storing an indication of which interstitial items have been played to consumers, the database 105 may store user data received from users who access the media content. Media server 106 is configured to store one or more receiving conditions of the content stream when a stream of media content is transmitted to one or more of the receiving devices 108, 109, 110.

The media playout system may further include an additional server 111 that can be accessed by any of the devices 108, 109, 110 over the internet 107. The additional server could be a web server. It could operate a commerce site such as an online shop or store, by means of which products or services can be acquired or consumed. The server 111 may have access to a data store 112 which holds the content to be provided to the server 111. That may, for example, be information defining a set of webpages to be served by the server 111, how to take payment for products or services, and how to initiate the supply of products or services once payment has been made.

When any of the receiving devices 108, 109, 110 accesses the server 111, the server 111 instructs the receiving device to report information to server 113 including the identity of the user of the receiving device and which content it was accessing from server 111. The receiving device transmits to server 113 one or more messages indicating the content that it was accessing from the server. The content may be identified in that/those messages by its address (e.g., URL) or any other identity such as its title or a unique reference by which the content is designated on server 111. Server 113 may add this to the history in database 105.

The above described is one example of a data management apparatus for establishing one or more personal characterisations of users, e.g., consumers. However, a number of parts of the above system may be grouped together, for example the server 111 and the data 112 may be combined in one unit. Similarly, all the components may be combined into a single apparatus possessing the capabilities of each of components 101 to 106 as well as components 111 and 112. The data management apparatus may be connected to the internet 107 or other connection means (such as Bluetooth etc.) in order to communicate with the user devices 108 to 110. For the remainder of this disclosure the term data management apparatus will be used generally to refer to the collective apparatus capable of performing the functions of components 101 to 106 as well as components 111 and 112 described above and may be thought of as a single apparatus having these capabilities or a distributed system as shown in FIG. 1.

In some example, non-limiting implementations, the user of a receiving device may be configured to access an audio stream and may be targeted with advertising, however, it should be understood that the current subject matter is not limited to audio streaming services and may be used in any appropriate setting where media is consumed or other ecommerce enterprises, for example a marketplace platform, such as, by way of a non-limiting example, EbayTM.

When a user of a receiving device (user device), such as a smartphone, tablet or personal computer, accesses an audio streaming service or radio station website the user receiving device will send baseline data that may include user attribute data to the apparatus. This data may be sent over the internet or directly from the user receiving device to the apparatus. This user attribute data is data that is received by the apparatus (the data management apparatus). The user attribute data is collected for all users who access an audio service without the need for user permission and may include one or more details about the user, such as general location information, the date/day, time, the type of device that is accessing the media content e.g., a phone or computer etc. and/or the stream/brand/station of media content that is being consumed. The user attribute information may also include usernames and passwords if login is required, more general login details, and/or how long the media content was accessed for. The user attribute data is a first set of data that is collected for the group of all users that access the content.

Generally, the group of users that access media content fall into two groups, a first group of users that allow additional cookie/preference data to be collected and a second group of users that do not allow additional data to be collected.

The first group of users, on giving permission, allow additional cookie data to be collected that is not intrinsic to the accessing of the content. This permission, granted by the user, may take place as the user first accesses the content and is prompted, possibly by a pop up, to allow permission to share this further data. The additional cookie data may relate to the behavioural characteristics of a user and be thought of as behavioural characteristic data. These behavioural characteristics may include information regarding the likes and dislikes of the user, other related or unrelated content that the user has accessed on the receiving device, the frequency with which the user has accessed the content, the email address of the user, the age and/or gender of the user, specific location information such as latitude and/or longitude, a unique internal user ID, a unique external user ID and/or items purchased by the user. The behavioural characteristics may therefore be thought of as Personal Identifiable Data and may also include characteristics gathered by third party websites or applications that are permitted to be shared. The one or more behavioural characteristics, about each user that has accepted cookie sharing permissions, that are input to and received by the apparatus from the user devices may be thought of as a second set of data. The second set of data represents, for each of the first group of users, the behavioural characteristics described above. This second set of data is received by the current subject matter’s apparatus from the user devices, either directly or via the internet.

Since the second group of users are users for whom a second set of data cannot be collected without permission, the only data that is available to the apparatus when a unique user from the second group of users accesses the media content is the baseline data. In other words, only the first set of data described above is received by the apparatus for the second group of users when the second group of users’ access media content.

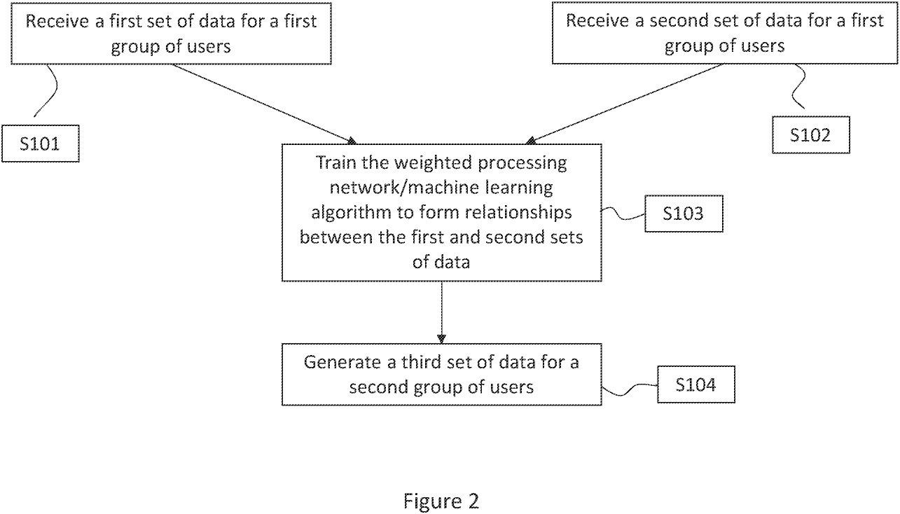

The processing of the user characteristic data will now be described with reference to FIG. 2.

The apparatus of the present disclosure, in particular the one or more processors within the apparatus, are configured to receive the first set of data from each of a group of users as shown in 101 of FIG. 2. The group of users may include a first group and a second group of users. This data is received in response to each user from the group of users accessing the media content. The first set of data may be stored by the apparatus as part of a database 105 or may be temporarily held in the cache of the apparatus.

Once the first set of data and the second set of data has been received by the apparatus, the apparatus is configured to use this data to train the weighted processing network, that is present in the apparatus, for each of the first group of users, associate their first set of data with their second set of data. In other words, the processors within the apparatus are configured to input, to the weighted processing network, the first and second sets of data that have been received for each of a first group of users and train the weighted processing network to recognise relationships between each user’s first set of data and their second set of data. To take a simplified example for one user from the first group of users, the weighted processing network of the present apparatus receives a first set of data representing one or more categories of user attribute data about that user. This data may be the time at which the media was accessed (a first category) and/or the location they are at when they accessed the media content (a second category). Since the user is one of the first group of users, the processors of the present apparatus and thus the weighted processing network will also receive a second set of data representing the behavioural characteristics of the user. This second set of data may be user preference data, for example, that the user visits a number of websites related to pet products, specifically related to dogs and/or that the user consumes the media content regularly at a set time window. The weighted processing network, which may be a machine learning algorithm executed/run by the apparatus, and more particularly the processors, will then form a relationship or link between the fact that the user accessed the media content at a certain location and that they have a preference for dogs. The weighted processing network will be trained to recognise these relationships and links between the first and second sets of data for each user of the first group of users.

The training of the weighted processing network and how the weighted processing network learns relationships between the data sets will now be further described. This process may be the same as performed, at S204, as described herein. The training of the weighted processing network may include a learning phase and a validation phase.

In the learning phase, the data from the first group of users may be used to create relationships between the first set of data and the second set of data, these may be thought of as the creation of behavioural segments. The learning process may include using data collected for each of a first group of users including both a first set of data and a second set of data. These sets of data for each of the first group of users may be received by the trained weighted processing network (machine learning algorithm) in advance as part of a large historical data set or may be received as each first user accesses the content or may be a combination of both. In some examples, the data sets input may have positive and negative associations between the first and second sets of data for a first group of users. For example, some of the first group of users may have first sets of data and be identified as small business owners while others may have different first sets of data and be identified in the negative as not being small business owners. In general, in the learning phase, for each of the first group of users a first set of data is received, and a second set of data is received. In some examples, the first set of data may be thought of as exploratory variables (user attributes) that are used to explore connections between the user attributes in order to provide predictions of second set of data, which may be thought of as prediction variables (behavioural characteristics) that may be linked to the first sets of data and predicted by the combinations of the user attributes that make up the first set of the data. In the example, each user may have an associated range of user attribute data of the first set of data and Boolean indicators representing positive or negative instances of behavioural characteristic data from the second set of data.

Both sets of data may be passed to an auto machine learning platform (AutoML) that may identify users that have a certain tag in the second set of data, for example, that they are a small business owner and identify which common first sets of data between each of the users who have said tag in the second set of data. In this way the weighted processing network (machine learning algorithm) can learn a relationship between the user attributes in the first set of data and the behavioural characteristics in the second set of data. Therefore, when a new user, who does not agree to share their second set of data, accesses the system and the user attributes of that user are at least partially similar to those of a learnt relationship, a numerical value may be placed on the probability that said new user (from a second group of users) has each of the behavioural characteristics of a second set of data. In other words, the new user may be predicted to be a, for example, a small business owner since their first set of data is similar to that of other confirmed small business owners. In this way, the weighted processing network is trained, in other words learns, associations/relationships between the first and second sets of data of first users that can then be used to predict/learn relationships and data sets of subsequent users and produce a third or subsequent data sets that are similar to the second and/or first data sets.

There may also be a validation phase. In this phase a probability threshold may be generated. This probability threshold may be used by the trained weighted processing network to determine whether a second user has a particular behavioural characteristic from a third set of data (equivalent to the second set of data from a first user). For example, given a second user’s first set of data that is allowed to be collected, there may be a correlation to a first user’s first set of data, who we know likes dogs. Depending on how strong the correlation e.g., how many of the user attributes in the first set of data of the first and second users is the same, a probability that the second user also likes dogs may be generated and this probability may have a set threshold that when reached, a second user is identified as liking dogs. The threshold may be adapted based on balancing two metrics, accuracy of the predictions, and the uplift in the size of the data inventory that the threshold would provide. For example, if the threshold is too high then while the identifications will be increasingly accurate, there will be fewer of them made as less will meet the threshold.

The process of validating the trained weighted processing network may then be used to confirm the optimal performance of the network. This may be done by using a separate sample of data from first and second data sets to that used to train the weighted processing network. This data may be input into the trained weighted processing network to produce a probability distribution of the possible predictions (second set of data) based on the input (first set of data) for the first and second groups of users.

Once probability distributions have been generated for possible second sets of data of a plurality of users having first sets of data, the probability threshold used to identify matches between the user attributes of the first sets of data and behavioural characteristics of the second sets of data may be adapted by testing different thresholds in order to achieve optimal matching. This may be thought of as fine tuning the relationships learnt by the trained weighted processing network.

In some cases, it may be useful to test the trained weighted processing network prior to implementing it in a live setting with real time data. In such cases, a large number of second users each with a first set of data but for who there is no second set of data are input into the trained weighted processing network and the uplift in behavioural characteristics that are generated as part of a third set of data (equivalent to/of the same type as the second set of data generated for the first group of users) for the second group of users is analysed. In some examples, it is beneficial to check that the third set of data that is generated for the second group of users includes realistic data, for example that the trained weighted processing network has not generated unrealistic values for a user based on the user attributes (first set of data) input. If the threshold is inappropriately set, then this may be adjusted at this stage to further refine the trained weighted processing network.

Since each subsequent user of the first group of users will have their first set of data linked to their second set of data and the weighted processing network will be trained to form links between the one or more categories of user attribute data and the one or more behavioural characteristics of the first group of users, as described above. To return to the above example, the weighted processing network may form a relationship from the input of data sets, from the first group of users, that a group of users who access media content at a certain location, for example a public park, and/or time, for example 3pm on a Saturday afternoon (category of user attribute data), are all interested in dogs (behavioural characteristic). This may be because there is a dog training class that takes place in a public park at 3pm on a Saturday afternoon and in the class music content is streamed by the attendees. The weighted processing network will therefore form a relationship between users who access media content in the public park at 3pm on a Saturday and the fact that they like or are interested in dogs. As discussed above, this relationship may be based on the first set of data from these users e.g., that they are consuming the content at 3pm, in a public park possibly by a mobile audio content means such as a smart phone. This combination of user attributes that make up the first set of data for these users may then lead to the generation of a second set of data that includes the likely age range, gender, specific location and/or interests, in this case the liking of dogs, for these users. Many such relationships are learnt by the weighted processing network and the strength of the relationships are increased with increasing amounts of user data.

In this way, the weighted processing network (machine learning algorithm) can constantly refine the weighting of the model that associates the one or more categories of user attribute data to the one or more behavioural characteristics. The more user data that is received by the apparatus the more the weighted processing network can be refined to strengthen the relationships that are formed. With every new combination of first and second sets of user data, the weighted processing network is constantly improving the relationships that it forms between the one or more categories of user attribute data and the one or more behavioural characteristics.

These relationships can be formed on a continual basis as the apparatus receives new first and second sets of data from users as they access the media content, or combinations of first sets of data and second sets of data with known relationships can be input into the apparatus and used to augment or enhance the relationships formed from the collected first and second sets of user data. This augmentation may take known data from a third party in order to improve and strengthen the relationships formed by the weighted processing network of the present apparatus.

Once the weighted processing network of the present apparatus has formed relationships based on the first and second sets of data for the first group of users, these relationships learnt by the weighted processing network can be used to generate a third set of data representing, for each of the users of the second group of users, one or more behavioural characteristics of those users. This is also discussed above. This third set of data is the unknown second set of data about the second group of users. In other words, the processors are configured to use the weighted processing network to generate, for the second group of users, a third set of data that is the same type of information (behavioural characteristics) as the second set of data for the first group of users. The apparatus is therefore configured to predict the unknown behavioural characteristic data for the second group of users and thus bridge the gap. This allows both the first and second groups of users to be targeted with advertisements.

To return once again to the example of the dog training class, a new user may attend the class and consume media content at the same time and general location as other users in the class, but the new user may not give permission for the second set of their data to be shared/collected (the behavioural data) and therefore the apparatus may only receive, for the new user, a first set of data, that includes one or more categories of user attribute data e.g., the time, 3pm, and general location that they accessed the content, in this example at the public park. This new user who has not allowed additional cookie data and thus only a first set of data is available, is an example of a user within the second group of users. Using the trained relationships formed from the first and second sets of data from the first group of users, the weighted processing network can generate for the new user, one or more behavioural characteristics (a second set of data). For example, since the new user has accessed the media content in the same general location as the other attendees (first group of users) of the dog training class, the weighted processing network may infer that there is a high probability that the new user likes/has a preference for dogs. The weighted processing network can then generate a second set of data for that new user that contains the behavioural characteristic that the new user likes dogs for example. This allows profiles containing user data to be built for new users and thus advertisements to be targeted at the new user based on this generated data. In the above example the new user may be served with adverts regarding dog toys, leads or other such dog related paraphernalia. This is advantageous as adverts can be more efficiently served to the new user based on their behavioural characteristics and thus there is an increased chance of user interest.

Once the apparatus, and the weighted processing network within the apparatus, has been trained using the data of the first group of users as described above, such that relationships between the first set of data and the second set of data have been formed, the apparatus can be used to generate data for further users, for example a third group of users.

The apparatus, and more specifically the processors, of the present disclosure is configured to receive, for a third group of users who have no users in common with the first and second groups of users, a fourth set of data representing one or more behavioural characteristics of those users. This fourth set of data is comparable to the second set of data collected for the first group of users. The third group of users here may be one or more users who were not used to the train the system and could be thought of as new users who have started consuming media content and have thus come into contact with the apparatus through accessing the content. In this case the apparatus may be configured to receive one or more behavioural characteristics of the third group of users despite user permission not being given for all behavioural characteristic data to be accessed (for example the user may have input one piece of behavioural characteristic data) and input this data to the trained weighted processing network. The weighted processing network will then generate, using the relationships formed by the trained weighted network, for the user from the third group of users (having one or more new/unique users), a fifth set of data representing one or more categories of user data and/or one or more behavioural characteristics of the users. In other words, the weighted processing network may generate data comparable to the first and second sets of data of the first group of users, but for the third group of users. In this way, given one or more behavioural characteristics and some user attribute data (fourth data forming part of the fourth set of data) of a user from the third group of users, the weighted processing network can generate data about that user that is unknown (fifth set of data) using the previously formed relationships. For example, the weighted processing network may determine that because a listener of an audio stream is listening to Heart radio, at 11am in Wood Green, London, and are aged 70 they are likely to be someone who is interested in gardening in an allotment (examples of behavioural characteristics) and listening on a portable radio (example of a user attribute). The unknown data may be thought of as a fifth set of data that may include data having the same characteristics and type as that of the first and second sets of data. For example, the fifth set of data may generate user attribute data for the third user (as seen in the first set of data) and/or preference information, e.g., that the user has a preference for pizza when ordering takeaway food, (as seen in the second set of data). In this way, the relationships formed by the weighted processing network can be used to generate previously unknown information about the new user from the third group of users. A profile containing all the information, generated and input, about the third user may be formed and this profile may be stored in the databases of the apparatus.

The apparatus may receive one or more categories of user attribute data comparable in its content to the first set of data collected for the first group of users. Having received this data about the third group of users, the apparatus may be configured to input this data to the weighted processing network. The weighted processing network may then generate the fifth set of data using the relationships previously learned and the one or more categories of user attribute data input.

In one example, the apparatus may be configured to receive for a unique user, user identification information and/or user listening habit data, e.g., one category of user attribute data and one behavioural characteristic. The apparatus is further configured to input this data to the weighted processing network for the unique user. The apparatus will then generate, for the unique user using the relationships formed by the weighted processing network, the fifth set of data representing one or more categories of user attribute data and/or one or more behavioural characteristics of the unique user. In this example, the unique user may be a single user from the third group of users or simply a previously unknown user who accesses the media (e.g., audio) content.

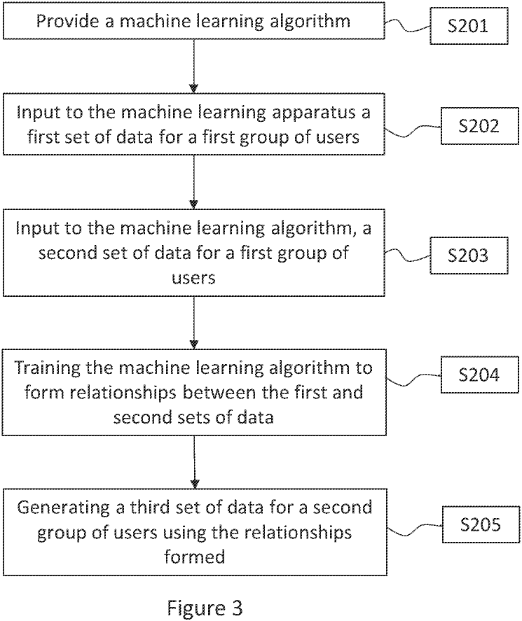

There is also provided in the present disclosure, a method of data management using machine learning for establishing one or more personal characterisations of users. This will now be described in relation to FIG. 3. This method may be applied to the use of the apparatus of described above and thus the above disclosure relating to the apparatus e.g., definitions of the first and second data sets etc also apply below. It should be understood however, that the below methods are not limited to being applied to the above apparatus and may be applied independently. Despite this, the terms previously discussed above such as first to fifth sets of data, first to third groups of users, unique users, and other definitions also apply to the method.

The method may, at S201, include providing a machine learning algorithm (weighted processing network). This machine learning algorithm is capable of learning relationships between user characteristic data based on inputs in order to be constantly improved and refined. This algorithm may be implemented by any of the one or more processors of an apparatus as discussed above and may be trained in the same way as described above e.g., using learning and/or validation and execution phases.

At S202, a first set of data is input into the provided machine learning algorithm. The first set of data in this method represents, for each user of a group of users, one or more categories of user attribute data, the group of users may include a first group of users and a second group of users, the first and second groups of users having no users in common.

At S203, a second set of data is input to the machine learning algorithm. The second set of data representing, for each of the users of the first group of users, one or more behavioural characteristics of each user.

The inputting, at S202 and S203, in which the first and second sets of data are input to the machine learning algorithm may be performed manually by the user from previously collected data. Alternatively, the sets of data may be input to the algorithm automatically as each user accesses the media content, either directly using the apparatus or over the internet. The sets of data may also be input value by value as each user accesses the content or in bulk as a set of multiple values representing many users who have access the content within a certain time period. The time period may be any time period specified by the operator of the apparatus.

Once the sets of data have been inputted, operation S204 may be executed, in which the machine learning algorithm (weighted processing network) is trained to form relationships between the first set of data and the second set of data for the first group of users for whom both data sets are available. In other words, the machine learning algorithm forms, for each of the first group of users, relationships between the categories of user attribute data of the first set of data and the behavioural characteristics of the second set of data. This is described above. This may be achieved by iteratively inputting the first and second data for each user into the machine learning algorithm, such that the algorithm knows the two sets of data are linked to the same user. The algorithm may repeat this process for each of the first users and at each iteration compare the linked first and second data for an initial first user to the linked first and second data for a subsequent one or more first users. The algorithm can, in this way, compare the links between the first and second data sets and the users within the first group of users and form relationships between the first and second data where common combinations occur. Returning the location and dog class for example, multiple users may have first data indicating their presence at the public park at a set time and second data indicating that they are interested in dogs. The algorithm can learn this connection as described above and form a relationship between the two sets of data. Another example, is that users who listen at certain time or for a certain length of time within a predetermined time window, say between 12am and 3am, may also have a preference or like of coffee (known from their search information) because they need to stay awake as they work a nightshift. The algorithm, given the first and second data, may therefore form a relationship between users who listen between 12am and 3am and the fact that they are more likely to be interested in coffee. This information can be used to serve more coffee advertisements during that time window.

Once these relationships have been formed, at step S204, a third set of data is generated, at S205. At S205, using the relationships formed by the machine learning algorithm, a third set of data is generated. The third set of data represents, for each of the users of the second group of users, one or more behavioural characteristics present in the second set of data. The generation of the third set of data will be based on the relationships previously formed in order to effectively fill in the missing data about the second group of users for which there is no behavioural characteristic data. For example, if a relationship has been formed that users who consume media content between 12am and 3am are interested in coffee, then when a second user is identified by the algorithm as consuming content within this time window, the algorithm will generate a second set of data for that user that includes that they are likely interested in coffee and thus can be targeted with advertisements of this type.

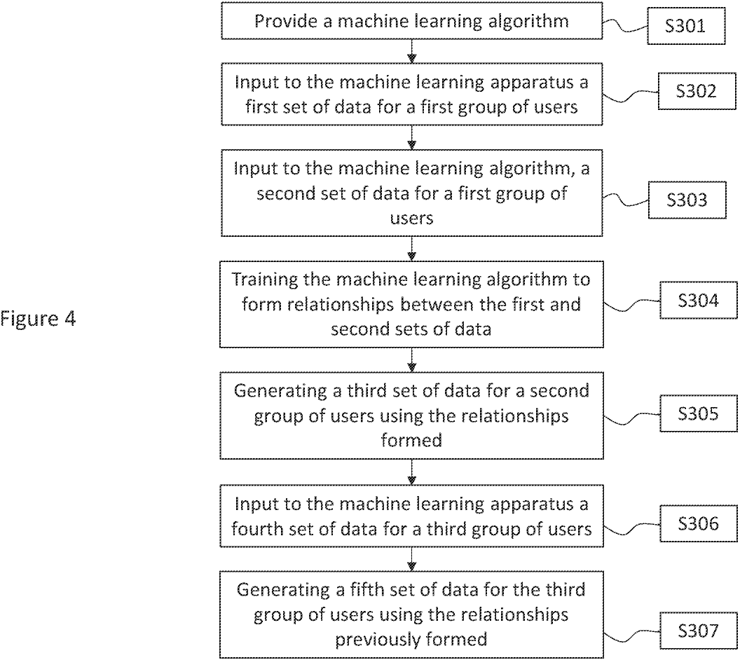

The method may also, optionally, include inputting for a third group of users who have no users in common with the first and second groups of users, a fourth set of data representing one or more behavioural characteristics and one or more user attributes, at S306, as shown in FIG. 4. Operations S301 to S305 shown in FIG. 4 may be similar to operations S201 to S205 discussed above in relation to and shown in FIG. 3.

Given this fourth set of data, the method may then include, at S307, generating, for the user from the third group of users, using the machine learning algorithm and the relationships formed, as discussed above, from the first and second data sets, a fifth set of data representing one or more categories of user data and/or one or more behavioural characteristics of the users. In this way, a new user/unique user for whom only one or more behavioural characteristics are known may be provided with a fifth generated set of data of the same kind as the first and second sets of data previously described. This allows a profile for the user to be built that contains, some identification information and preference information e.g., first and second sets of data (both forming the fifth set of data). Therefore, given only one behavioural characteristic of a third user, who may be a new user, a complete set of data can be generated based on the input data and the previously generated relationships.

Furthermore, either of the previous methods may include for a new user/unique user who accesses the media content for the first time, one or more of the following further operations. Inputting to the machine learning algorithm, one or more entries of user identification information (user attribute data) and/or one or more entries of user listening habit data specific to a unique user and generating using the machine learning algorithm the fifth set of data for the unique user. The user listening habit data may be based on the audio content consumption of the first group of users, for example, when, for how long etc. the user consumes data. The method may allow additional data, not originally disclosed as part of accessing the media content, to be generated for a unique user based on one or more entries of data of the type of the first set of data and/or one or more entries of data of the type of the second set of data. In this way, a profile including numerous data entries can be generated using the relationships previously formed and very few known data entries about a new user. This allows the number of new users for which data can be generated to be increased.

As such, the method may include generating, given a single data item from the first set of data for a unique user, first and second data associated to the unique (new) user; inputting to the machine learning algorithm a single category of the one or more categories from the first set of data for a user of the first group of users; generating, using the machine learning algorithm, first and/or second data sets associated to the unique user. This allows sets of data to be generated for new users/unique users, based on only one data input thus expanding the applicability of the method where data is scarce. In this way data can be generated for large groups of users given only basic data. During these operations, by way of a non-limiting example, one category of the one or more categories of attribute data relate to a single data entry, for example a location associated to the user when they accessed the media content.

The relationships formed by the machine learning algorithm may be further refined after the initial relationships have been generated by inputting further users for which there is known one or more categories of user attribute data (e.g., first set of data) and one or more behavioural characteristics. In this way, new users for which a large amount of data is known can be used to bolster and reinforce the relationships previously in the method and the apparatus. In addition, such users may be used to further expand the known relationships of the algorithm and allow new relationships to be formed in the same way as previously discussed.

In addition, the relationships formed by the machine learning algorithm/weighted processing network are not limited to one-to-one relationships and one entry of either first or second data may be used to create multiple relationships. For example, an entry of location information may be linked to a number of preferences for that user. The relationships formed between the first and second data sets of the first users may be relationships between individual entries of first and second data and/or relationships between subgroups of entries of first and second data. The relationships formed can be formed on the basis of categories for example based on behavioural characteristics may be specific such as a user liking dogs or may be formed more broadly for example, that the user likes animals. This can be done based on the second data received from the first group of users as the machine learning algorithm may be configured to analyse the input/received data and group entries based on properties of those entries. To take the above example if two users show behavioural characteristics that they like either cats or dogs, they may be more widely grouped as users who like animals with a higher degree of certainty as the probability generated by the trained weighted processing network may be higher. The categories and the grouping of data can be set by the operator based on the implementation of the system or may be learnt by the machine learning algorithm autonomously.

The apparatus may be used to control a further media content apparatus in order to intersperse advertisements into live content or pre-recorded content. The advertisements may also be customised for each particular user listening to media content. For example, the core content may be the same for all users, but the advertisements served in the breaks in the core content may be tailored and specific to each user and thus may differ from user to user based on their behavioural characteristics (behavioural characteristic data).

It should be noted that the data collected about a user and the profile generated for that user may not be limited to being utilised to serve advertisements. The apparatus may also be employed to recognise trends in the interests of users based on the behavioural characteristics of groups of users. This could be used by companies to inform market trends and develop products to meet the needs to the user.

The apparatus and method of the present disclosure may not only be implemented as above and instead of the above application to audio content consumers and media content consumers the apparatus and method may be used in a number of other industrial applications. A further use for the apparatus and method may be to inform town planning, traffic light systems, placement of telecoms towers. To briefly return to the dog training example, the data generated for the second and subsequent groups of users and the relationships formed by the analysis of the first and second a data sets of the first users, could be utilised in town planning. For example, the relationships formed by the algorithm that users who consume content at the location of a public park are also interested in dogs and attend dog training classes may be used to make informed decisions about pedestrianisation of areas of town when town planning. In addition, since users, given the relationship formed likely own dogs and are at that location within a certain time window, it may be beneficial to use the apparatus or method data to control the schedule of a traffic light system/industrial apparatus, in order to direct traffic away from the area during this time window.

In a similar example, the apparatus and method could be applied to the allocation of telecommunications network resources. In this example application, a first group of users would provide a first set of data including basic location information when accessing online/telecoms content and second data representing more detailed information relating to the use of the content, including how often they access this content, what kind of data they access e.g. videos, text. These sets of data can be thought of as first and second sets of data and can be used by the apparatus to train the weighted processing network (machine learning algorithm) to form relationships between these sets of data. These relationships can be applied to other users who for example access the content in the same location in order to generate/predict/infer further details about the content that this second group of users. The total data and the relationships formed can then be used to adapt a distributed telecoms network to more efficiently allocate resources for users in a particular environment e.g., an office space or city suburb. In this way, the apparatus can be used to optimise the resource allocation of the telecoms network and/or the placement of telecoms infrastructure in order to optimise coverage.

A further example of the apparatus could be as part of a financial modelling platform. The groups of users may be users who access a financial trading platform and thus behavioural characteristics for a second or subsequent groups of users could be generated using the machine learning algorithm and relationships formed from a first group of users. This could advantageously be used to make informed suggestions regarding the movement of these markets.

The present disclosure hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The present disclosure indicates that aspects of the current subject matter may include any such individual feature or combination of features. In view of the foregoing description, it will be evident to a person skilled in the art that various modifications may be made within the scope of the current subject matter.

One or more aspects of at least one implementation of the current subject matter may be implemented by representative instructions stored on a machine-readable medium which represents various logic within the processor, which when read by a machine causes the machine to fabricate logic to perform the techniques described herein. Such representations, known as “IP cores”, may be stored on a tangible, machine readable medium. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writable or rewritable media, digital or analog media, hard disk, floppy disk, Compact Disk Read Only Memory (CD-ROM), Compact Disk Recordable (CD-R), Compact Disk Rewritable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and/or features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not imply that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some implementations may be described using the expression “one embodiment” or “an embodiment” or “one implementation” or “an implementation” along with their derivatives. These terms mean that a particular feature, structure, or characteristic described in connection with the embodiment is included in at least one embodiment. The appearances of the phrase “in some implementations” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the abstract of the disclosure is provided to allow a reader to quickly ascertain the nature of the technical disclosure. It is submitted with the understanding that it will not be used to interpret or limit the scope or meaning of the claims. In addition, in the foregoing detailed description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the detailed description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed:

1. A data management apparatus for establishing one or more personal characterisations of users, the data management apparatus comprising one or more processors configured to:
receive a first set of data representing, for each user of a group of users, one or more categories of user attribute data, the group of users including a first group of users and a second group of users, the first and second groups of users having no users in common;
receive a second set of data representing, for each of the users of the first group of users, one or more behavioural characteristics;
train a weighted processing network to form, for each of the first group of users, relationships between the categories of user attribute data of the first set of data and the behavioural characteristics of the second set of data; and
generate, using the relationships formed by the trained weighted processing network, a third set of data representing, for each of the users of the second group of users, one or more behavioural characteristics present in the second set of data.

2. The data management apparatus according to claim 1, wherein the one or more processors are further configured to:
receive, for a third group of users who have no users in common with the first and second groups of users, a fourth set of data representing one or more behavioural characteristics;
input to the trained weighted processing network the fourth set of data; and
generate, using the relationships formed by the trained weighted network, for the user from the third group of users, a fifth set of data representing one or more categories of user data and/or one or more behavioural characteristics of the users.

3. The data management apparatus according to claim 1, wherein the user attribute data includes user identification information.

4. The data management apparatus according to claim 3, wherein the user identification information is an email address.

5. The data management apparatus according to claim 4, wherein the one or more behavioural characteristics include user listening data having information about user listening habits based on the audio content consumption of the first group of users.

6. The data management apparatus according to claim 2, wherein the one or more processors are further configured to:
receive user identification information and/or user listening habit data specific to a unique user; and
generate, using the trained weighted processing network, a fifth set of data for the unique user.

7. The data management apparatus according to claim 1, wherein the one or more processors are further configured to:
receive a single category of the one or more categories from the first set of data for a user of the first group of users; and
generate, using the trained weighted processing network, first and/or second sets of data associated to the unique user.

8. The data management apparatus according to claim 1, wherein the second set of data includes information relating to the user’s preferences and/or interests.

9. The data management apparatus according to claim 1, wherein the weighted processing network is a machine learning algorithm.

10. The data management apparatus according to claim 1, wherein, in training the weighted processing network to form relationships between the first set of data and the second set of data, the one or more processors are configured to:
compare the first sets of data and the second sets of data for each of the first group of users to other users from the first group of users; and
identify combinations of the one or more user attributes from the first sets of data that are present in combination with one or more behavioural characteristics, for a plurality of users from the first group of users.

11. The data management apparatus according to claim 1, wherein, when generating the third set of data for the second group of users, the one or more processors are further configured to:
generate one or more probabilities that each of the second group of users has one or more behavioural characteristics that form the third set of data based on one or more user attributes that form the first set of data for the second group of users, wherein the probability is based on the relationships formed between the first set of data and the second set of data of the first group of users.

12. A method of data management using machine learning for establishing one or more personal characterisations of users, the method comprising:
providing a machine learning algorithm;
inputting, to the machine learning algorithm, a first set of data representing, for each user of a group of users, one or more categories of user attribute data, the group of users including a first group of users and a second group of users, the first and second groups of users having no users in common;
inputting, to the machine learning algorithm, a second set of data representing, for each of the users of the first group of users, one or more behavioural characteristics;
training the machine learning algorithm to form, for each of the first group of users, relationships between the categories of user attribute data of the first set of data and the behavioural characteristics of the second set of data; and
generating, using the relationships formed by the machine learning algorithm, a third set of data representing, for each of the users of the second group of users, one or more behavioural characteristics present in the second set of data.

13. The method of claim 12, further comprising
inputting to the machine learning algorithm for a third group of users who have no users in common with the first and second groups of users, a fourth set of data representing one or more behavioural characteristics; and
generating, for the third group of users, using the machine learning algorithm and the relationships formed from the first and second data sets, a fifth set of data representing one or more categories of user data and/or one or more behavioural characteristics of the users.

14. The method according to claim 13, wherein the user attribute data includes a user identification information.

15. The method according to claim 12, wherein the one or more behavioural characteristics include user listening data having information about user listening habits based on the audio content consumption of the first group of users.

16. The method according to claim 15, further comprising
inputting, to the machine learning algorithm, user identification information user and/or user listening habit data specific to a unique user; and
generating, using the machine learning algorithm the fifth set of data for the unique user.

17. The method according to claim 12, further comprising
inputting to the machine learning algorithm a single category of the one or more categories from the first set of data for a user of the first group of users; and
generating, using the machine learning algorithm, first and/or second data associated to the unique user.

18. The method according to claim 12, wherein the second set of data includes information relating to the user’s preferences and/or interests.

19. The method according to claim 12, wherein, in training the machine learning algorithm to form relationships between the first set of data and the second set of data, the method further comprising
comparing the first sets of data and the second sets of data for each of the first group of users to the first and second data sets for each of the other users from the first group of users; and
identifying combinations of the one or more user attributes from the first sets of data that are present in combination with one or more behavioural characteristics, for a plurality of users from the first group of users.

20. The method according to claim 12, wherein the generating includes
generating one or more probabilities that each of the second group of users has one or more behavioural characteristics that form the third set of data based on one or more user attributes that form the first set of data for the second group of users, wherein the probability is based on the relationships formed between the first set of data and the second set of data of the first group of users.
